(19) United States
(12) Patent Application Publication
(10) Pub. No.: US 2023/0012384 A1
(43) Pub. Date: Jan. 12, 2023

(54) FRAME STRUCTURE OF LIFT CARRIER

(71) Applicant: TOYOTA JIDOSHA KABUSHIKI KAISHA, Toyota-shi Aichi-ken (JP)

(72) Inventors: Toshiki Kitajima, Mishima-shi Shizuoka-ken (JP); Norinao Watanabe, Susono-shi Shizuoka-ken (JP); Yutaka Nakamura, Susono-shi Shizuoka-ken (JP); Naoya Kajita, Toyota-shi Aichi-ken (JP); Kenji Nakano, Toyota-shi Aichi-ken (JP); Takafumi Sannomiya, Okazaki-shi Aichi-ken (JP); Yasutada Shimizu, Okazaki-shi Aichi-ken (JP); Kohei Yasuda, Susono-shi Shizuoka-ken (JP)

(73) Assignee: TOYOTA JIDOSHA KABUSHIKI KAISHA, Toyota-shi Aichi-ken (JP)

(21) Appl. No.: 17/828,547

(22) Filed: May 31, 2022

(30) Foreign Application Priority Data
Jul. 12, 2021 (JP) 2021-115047

(51) Int. Cl. B66F 7/28

(52) U.S. Cl. CPC B66F 7/28; B66F 2700/12

(57) ABSTRACT

A lift carrier includes: a bogie frame that is inserted under a transport target vehicle; an elevating mechanism that raises and lowers the bogie frame with each of a plurality of tires supported with arms to raise and lower a vehicle; a bogie body that is able to move the bogie frame to any location. The bogie frame includes a main frame and a rear end frame joined to the main frame. The rear end frame is formed in a rectangular shape by a pair of side members, a first cross member, and a second cross member. The rear end frame includes a first reinforcing member projecting from the first cross member toward a front end side and a second reinforcing member projecting from the first cross member toward a rear end side. The first reinforcing member is joined to a part of the main frame.

### CROSS-REFERENCE TO RELATED APPLICATION

This application claims priority to Japanese Patent Application No. 2021-115047 filed on Jul. 12, 2021, incorporated herein by reference in its entirety.

### BACKGROUND

### 1. Technical Field

The present disclosure relates to a technique for a frame structure of a lift carrier for transporting a vehicle.

### 2. Description of Related Art

Japanese Unexamined Patent Application Publication No. 2019-78099 (JP 2019-78099 A) discloses a technique related to a lift carrier that supports a vehicle, raises and lowers the vehicle, and enables transportation of the vehicle. In the lift carrier of this technique, each tire is supported by an arm portion with a bogie frame inserted under the vehicle. The bogie frame is raised and lowered by a base end elevating portion and a tip elevating portion to raise and lower the vehicle. A bogie body is connected to the bogie frame. The bogie body includes a drive wheel unit and a transport control unit, and transports the vehicle in any direction.

### SUMMARY

An arm portion that supports the tires is supported on the bogie frame. When the vehicle to be transported is raised and lowered, the load of the vehicle is received by the arm portion, so that the bogie frame is required to have sufficient strength to support the load of the vehicle. However, since the bogie frame needs to be inserted under the vehicle, the size in the height direction is limited. Therefore, the lift carrier is required to have a frame structure for ensuring the strength to support the vehicle in a limited height space.

The present disclosure has been made in view of the above-mentioned problems, and an object of the present disclosure is to provide a frame structure of a lift carrier for ensuring strength for supporting a vehicle to be transported in a limited height space.

In order to solve the above problems, the present disclosure is suitable for the frame structure of the lift carrier. A lift carrier includes: a bogie frame that is inserted under a transport target vehicle in a vehicle front-rear direction; a plurality of arms configured to project outward from the bogie frame in a vehicle width direction at front and rear of ground contact portions of a plurality of tires of the transport target vehicle to support each of the tires in a supported state; an elevating mechanism that raises and lowers the bogie frame in the supported state to raise and lower the transport target vehicle; and a bogie body that is connected to a front end side of the bogie frame and is able to move the bogie frame to any location in the supported state. The bogie frame is configured to include a main frame extending from the front end side to a rear end side, and a rear end frame joined to the main frame on the rear end side of the bogie frame. The arms are provided on both sides of the main frame in the vehicle width direction and on both sides of the rear end frame in the vehicle width direction. The rear end frame includes a pair of side members, a distance between the side members in the vehicle width direction being wider than a width of the main frame, a first cross member joined to ends of the side members on the front end side and to which the main frame is joined, a second cross member joined so as to connect ends of the side members on the rear end side, a first reinforcing member joined to the first cross member so as to project from the first cross member toward the front end side, and a second reinforcing member joined to the first cross member so as to project from the first cross member toward the rear end side. The first reinforcing member is configured to be joined to a part of the main frame.

In the frame structure of the lift carrier of the present disclosure, the first reinforcing member and the second reinforcing member may be configured as one integrated reinforcing member. In this case, the first cross member is divided into two at a divided portion at the center, and the reinforcing member is configured to be joined between the divided portion.

In the frame structure of the lift carrier of the present disclosure, the second reinforcing member may extend to a position in contact with the second cross member of the rear end frame, and the second reinforcing member may be joined to the second cross member.

In the frame structure of the lift carrier of the present disclosure, the main frame may include a pair of side members each having a square closed section and arranged side by side in parallel on right and left, and a bottom plate joined to a lower side of the side members. The first reinforcing member may be configured to be joined to the bottom plate.

In the frame structure of the lift carrier of the present disclosure, the main frame may include a top plate joined to an upper surface side of the side members. The top plate may be provided with one or a plurality of through holes at a position overlapping with the first reinforcing member, and the first reinforcing member and the top plate may be configured to be joined via the one or the plurality of through holes.

In the frame structure of the lift carrier of the present disclosure, the bottom plate may extend to a position overlapping with the first cross member, and the bottom plate may be configured to be joined to the first cross member.

According to the present disclosure, the first reinforcing member projecting from the first cross member toward the front end side is provided, and the first reinforcing member is configured to be joined to a part of the main frame. According to such a configuration, the joint portion between the main frame and the rear end frame can be reinforced without increasing the thickness of the bogie frame. This makes it possible to secure the strength for supporting the vehicle to be transported in a limited height space.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a lift carrier 10 according to an embodiment of the present disclosure;

FIG. 2 is a top view of the lift carrier 10, and shows a case where a first arm group 211 and a second arm group 212 are in the released state in an operation of supporting a vehicle;

FIG. 3 is a top view of the lift carrier 10, and shows a case where the first arm group 211 and the second arm group 212 are in the supported state;

FIG. 4 is a side view of the lift carrier 10 and shows an example of an operation of lifting a transport target vehicle 1;

FIG. 5 is a side view of the lift carrier 10 and shows an example of the operation of lifting the transport target vehicle 1;

FIG. 6 is a top view of the lift carrier 10;

FIG. 7 is a perspective view of the lift carrier 10 cut along A-A in FIG. 6 and viewed from diagonally above;

FIG. 8 is a top view of a rear end frame 40 of the lift carrier 10 and its surroundings;

FIG. 9 is a perspective view of a joint portion between a main frame 30 and the rear end frame 40 as viewed diagonally from the front;

FIG. 10 is a perspective view of the joint portion between the main frame 30 and the rear end frame 40 as viewed diagonally from the rear;

FIG. 11 is an enlarged perspective view of the joint portion between the main frame 30 and the rear end frame 40 as viewed from the lower surface side of the vehicle;

FIG. 12 is a perspective view of a bogie frame 200 cut along B-B in FIG. 6 and viewed from diagonally above; and

FIG. 13 is a perspective view of the joint portion between the main frame 30 and the rear end frame 40 of the lift carrier 10 according to a modification as viewed diagonally from the front.

### DETAILED DESCRIPTION OF EMBODIMENTS

Embodiments of the present disclosure will be described below with reference to the drawings. However, in the following embodiments, when the number, a quantity, an amount, or a range of each element, for example, is mentioned, the disclosure is not limited to the mentioned number, etc., unless otherwise specified or except for the case where the number is obviously limited to the number mentioned in the embodiments in principle. Further, configurations, etc. that will be described in the following embodiments are not necessary to the present disclosure, unless otherwise specified or except for the case where configurations are obviously limited to the configurations mentioned in the embodiments in principle.

### 1. Lift Carrier

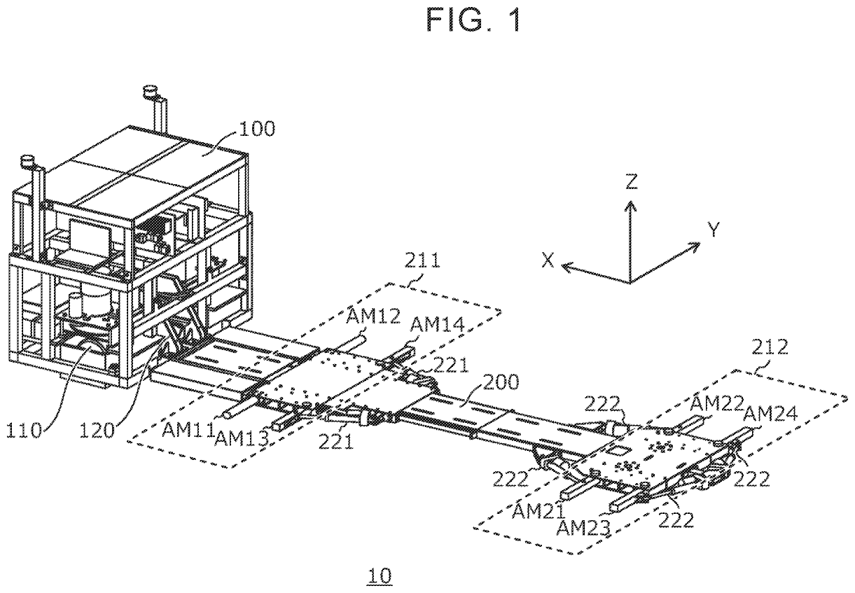

FIG. 1 is a perspective view of a lift carrier 10 according to an embodiment of the present disclosure. The lift carrier 10 includes a bogie body 100 and a bogie frame 200. The bogie body 100 is connected to the front end side of the bogie frame 200. The lift carrier 10 travels in the longitudinal direction of the bogie frame 200. In the following description, the traveling direction of the lift carrier 10 (vehicle front-rear direction) is defined as the X direction, the right-left direction of the lift carrier 10 (vehicle width direction) is defined as the Y direction, and the up-down direction of the lift carrier 10 is defined as the Z direction. As for the traveling direction of the lift carrier 10, the front direction of the vehicle is defined as the +X direction.

The bogie body 100 includes a traveling device 110 that provides a traveling function of the lift carrier 10 and an elevating mechanism 120 that provides an elevating function of the bogie frame 200. The traveling device 110 moves the bogie frame 200 and the vehicle mounted on the bogie frame 200 by driving drive wheels with an actuator. The drive mechanism of the traveling device 110 is not limited. Further, the traveling device 110 may be configured to be movable to any location by remote operation or autonomous traveling.

The elevating mechanism 120 is typically operated by an actuator. The mechanism of the elevating mechanism 120 is not limited. For example, the bogie frame 200 may be raised and lowered by a hydraulic cylinder, or the bogie frame 200 may be raised and lowered by using air pressure.

The bogie body 100 also includes a power source and a control device (not shown in FIG. 1). The power source supplies power to various actuators provided in the lift carrier 10. Typically, the power source is a battery, which is electrically connected to each of the actuators by a wire harness.

The control device outputs control signals for driving and controlling the various actuators provided in the lift carrier 10. The actuators operate according to the control signals. The control device is configured to be able to transmit information to each of the actuators. Typically, the control device is electrically connected to each of the actuators by a wire harness.

The control device may be a device provided outside the lift carrier 10. In this case, the control device is configured to be able to transmit information to each actuator by communication.

The bogie frame 200 includes a first arm group 211 and a second arm group 212. The lift carrier 10 inserts the bogie frame 200 under the vehicle in the front-rear direction of the four-wheeled vehicle, and the first arm group 211 and the second arm group 212 each sandwich the front tires and the rear tires of the vehicle to support the vehicle. Typically, the lift carrier 10 inserts the bogie frame 200 from the front of the vehicle. That is, the first arm group 211 sandwiches the front tires of the vehicle, and the second arm group 212 sandwiches the rear tires of the vehicle to support the vehicle. Alternatively, the bogie frame 200 may be inserted from the rear of the vehicle to support the vehicle. The lift carrier 10 raises the bogie frame 200 and moves a transport target vehicle in a lifted state to transport the vehicle.

The operation of sandwiching the tires of the transport target vehicle by the first arm group 211 and the second arm group 212 is each realized by first arm actuators 221 and second arm actuators 222. The first arm group 211 includes fixed arms AM11, AM12 and movable arms AM13, AM14. The fixed arm AM11 and the movable arm AM13, and the fixed arm AM12 and the movable arm AM14 each form a pair and sandwich the front and rear of the ground contact portions of the tires. The fixed arms AM11, AM12 are fixed so as to project in the Y direction from the bogie frame 200. Therefore, the tires are sandwiched and released by movement of the movable arms AM13, AM14. The movable arms AM13, AM14 are moved by the first arm actuators 221. Typically, the movable arms AM13, AM14 are fixed to the bogie frame 200 so as to be rotatable within a predetermined range with their roots as support points. The first arm actuators 221 operate to switch between the supported state where the movable arms AM13, AM14 and the fixed arms AM11, AM12 sandwich the front and rear of the ground contact portions of the tires by causing the axial direction of the movable arms AM13, AM14 to face the Y direction, and the released state where the tires are released by causing the axial direction of the movable arms AM13, AM14 to face the X direction.

The second arm group 212 includes movable arms AM21, AM22, AM23, AM24. The movable arm AM21 and the movable arm AM23, and the movable arm AM22 and the movable arm AM24 each form a pair and sandwich the front and rear of the ground contact portions of the tires. The movable arms AM21, AM22, AM23, AM24 are individually moved by second arm actuators 222. Typically, the movable arms AM21, AM22, AM23, AM24 are fixed to the bogie frame 200 so as to be rotatable within a predetermined range with their roots as support points. The second arm actuators 222 operate to switch between the supported state where the front and rear of the ground contact portions of the tires are sandwiched by causing the axial direction of the movable arms AM21, AM22, AM23, AM24 to face the Y direction, and the released state where the tires are released by causing the axial direction of the movable arms AM21, AM22, AM23, AM24 to face the X direction.

### 2. Vehicle Transport Operation by Lift Carrier

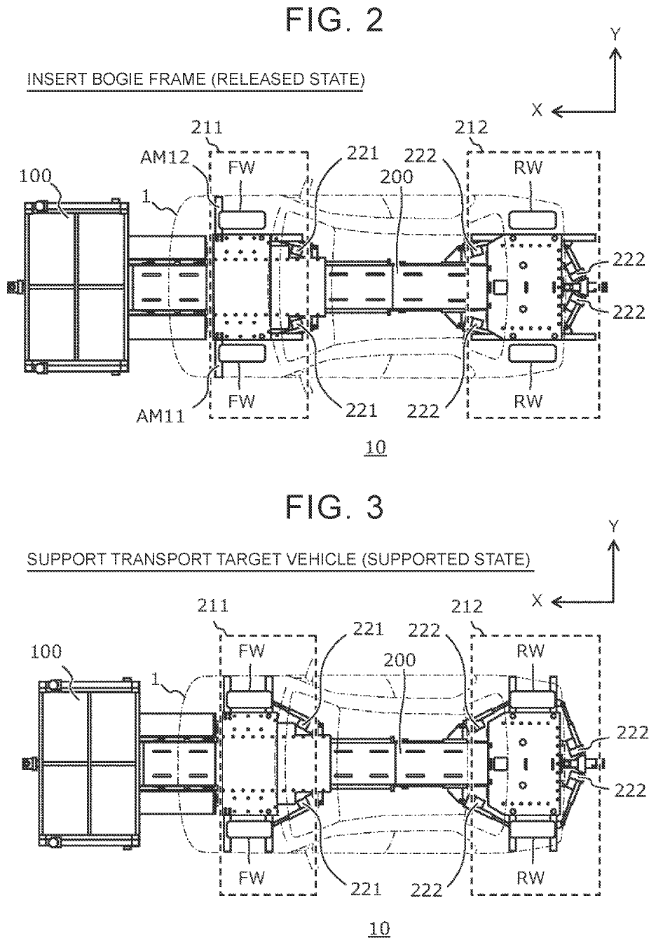

Next, with reference to FIGS. 2 and 3, the operation related to the transportation of the transport target vehicle 1 by the lift carrier 10 according to the present embodiment will be described. Here, a case where the lift carrier 10 inserts the bogie frame 200 from the front of the transport target vehicle 1 is illustrated.

FIG. 2 is a top view of the lift carrier 10, and shows a case where the first arm group 211 and the second arm group 212 are in the released state in the operation of supporting the vehicle. FIG. 3 is a top view of the lift carrier 10, and shows a case where the first arm group 211 and the second arm group 212 are in the supported state. In FIG. 2 and FIG. 3, the transport target vehicle 1 is represented by long dashed short dashed lines and is seen through.

As shown in FIG. 2, the lift carrier 10 sets the first arm group 211 and the second arm group 212 to the released state, and inserts the bogie frame 200 under the transport target vehicle 1 from the front of the transport target vehicle 1. At this time, the lift carrier 10 inserts the bogie frame 200 until the fixed arms AM11, AM12 come into contact with the front tires FW of the transport target vehicle 1. That is, the fixed arms AM11, AM12 function as guides for determining the insertion position of the bogie frame 200. Next, as shown in FIG. 3, by setting the first arm group 211 and the second arm group 212 in the supported state, the first arm group 211 and the second arm group 212 each sandwich the front tires FW and the rear tires RW of the transport target vehicle 1.

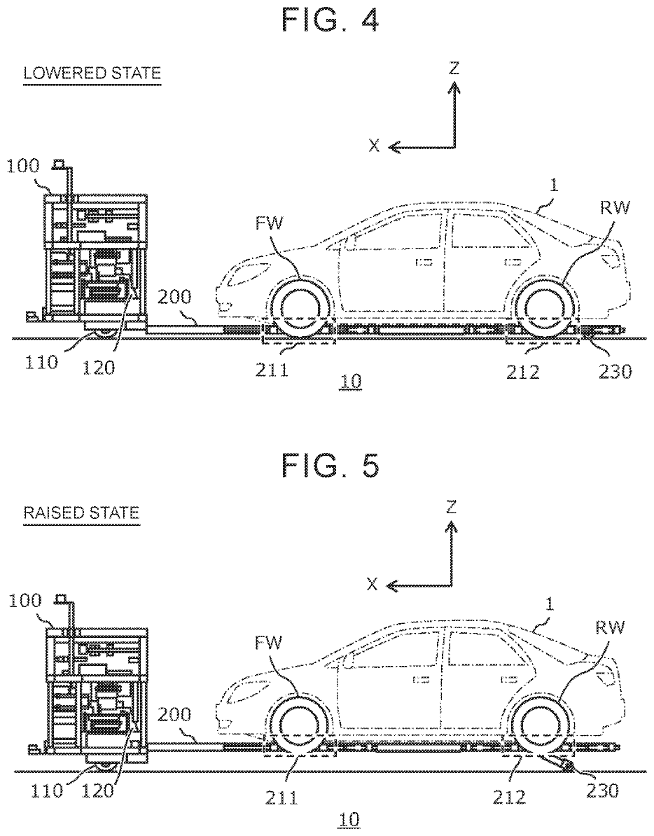

FIG. 4 and FIG. 5 are side views of the lift carrier 10 and show an example of an operation of lifting the transport target vehicle 1. As shown in FIG. 4, the lift carrier 10 sandwiches the tires FW, RW of the transport target vehicle 1 each with the first arm group 211 and the second arm group 212. Then, as shown in FIG. 5, the lift carrier 10 lifts the transport target vehicle 1 by raising the bogie frame 200 with the elevating mechanism 120.

Here, as shown in FIG. 5, wheels 230 of the bogie frame 200 are configured to be able to come into contact with the ground and roll on the ground even when the bogie frame 200 is raised. For example, the lift carrier 10 includes an actuator that operates to maintain the position of the wheels 230 against the elevation of the bogie frame 200. The lift carrier 10 transports the transport target vehicle 1 by driving the traveling device 110 of the bogie body 100 in a state where the transport target vehicle 1 is lifted.

### 3. Characteristic Structure of Lift Carrier of Present Embodiment

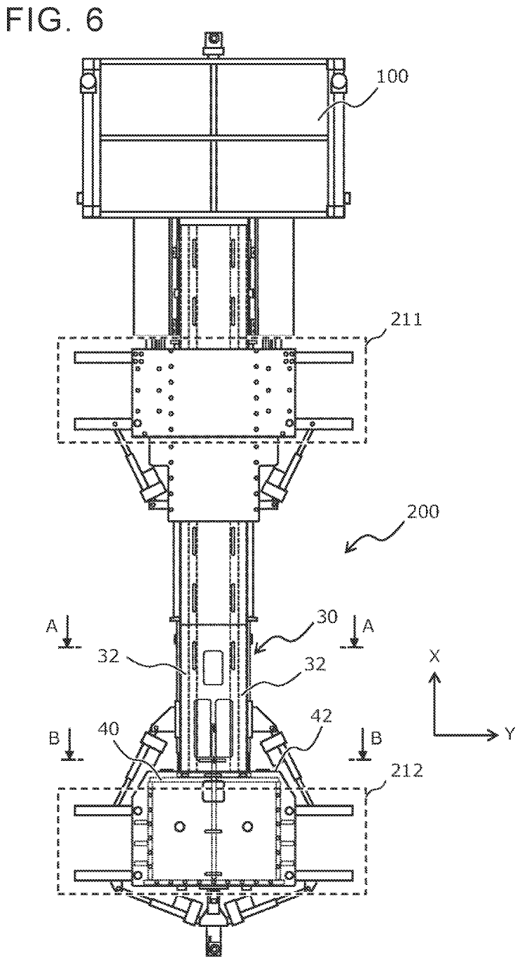

FIG. 6 is a top view of the lift carrier 10. As shown in FIG. 6, the bogie frame 200 includes a main frame 30 on the front end side that supports the first arm group 211 and a rear end frame 40 on the rear end side that supports the second arm group 212. The main frame 30 includes a pair of side frames 32 arranged along the vehicle front-rear direction (X direction). The upper surface side of the rear end frame 40 is covered with a cover 42. The pair of side frames 32 of the main frame 30 and the rear end frame 40 are joined by welding.

The first arm group 211 is provided on both sides of the main frame 30 in the vehicle width direction. The second arm group 212 is provided on both sides of the rear end frame 40 in the vehicle width direction. The weight of the transport target vehicle 1 is applied to the first arm group 211 and the second arm group 212. Therefore, a large bending moment acts on the joint portion between the main frame 30 and the rear end frame 40 when the transport target vehicle 1 is raised. Further, since the bogie frame 200 has a structure to be inserted under (under the floor of) the transport target vehicle 1, there are restrictions on the dimensions in the height direction. Therefore, the joint portion between the main frame 30 and the rear end frame 40 of the bogie frame 200 is required to have a structure for ensuring strength within a limited height restriction.

The inventors of the present disclosure have conducted extensive research on the frame structure for ensuring the strength of the bogie frame 200. As a result, the inventors of the present disclosure have found a frame structure in which the strength of the bogie frame 200 is increased while suppressing the thickness of the bogie frame 200 in the height direction.

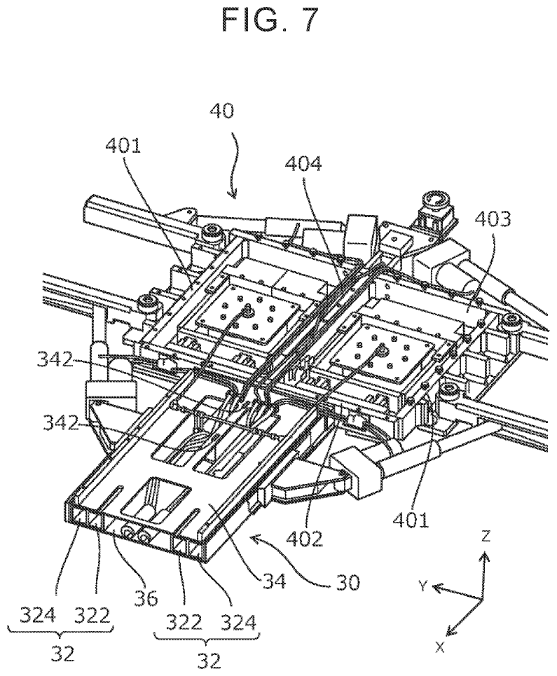

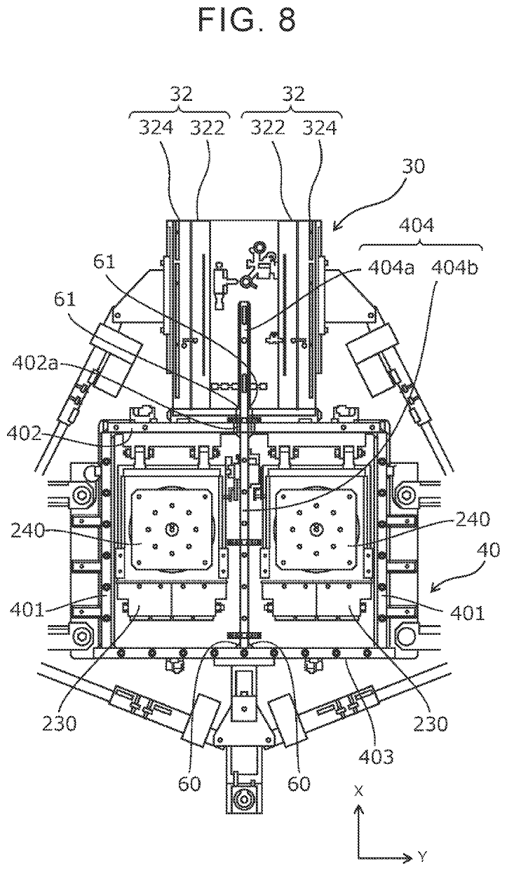

FIG. 7 is a perspective view of the lift carrier 10 cut along A-A in FIG. 6 and viewed from diagonally above. FIG. 7 illustrates a state in which the cover 42 covering the upper surface of the rear end frame 40 is removed to expose the frame structure. FIG. 8 is a top view of the rear end frame 40 of the lift carrier 10 and its surroundings. FIG. 8 illustrates a state in which the cover 42 of the rear end frame 40 and a top plate 34 of the main frame 30 are removed to expose the frame structure.

### 3-1. Characteristic Structure of Main Frame 30

The main frame 30 includes the pair of side frames 32 arranged along the vehicle front-rear direction (X direction), the top plate 34, and a bottom plate 36. The pair of side frames 32 includes a pair of outer side frames 324 arranged in parallel at a distance, and a pair of inner side frames 322 closely arranged inside each of the pair of outer side frames 324. Both the outer side frames 324 and the inner side frames 322 have a square closed sectional shape. The outer side frames 324 and the inner side frames 322 are joined to each other by welding. The top plate 34 and the bottom plate 36 are each joined to the upper surface side and the lower surface side of the pair of side frames 32 by welding.

### 3-2. Characteristic Structure of Rear End Frame 40

The rear end frame 40 is joined to the rear end side of the main frame 30. The rear end frame 40 includes a pair of side members 401, a first cross member 402, a second cross member 403, and a reinforcing member 404.

The pair of side members 401 are arranged along the vehicle front-rear direction (X direction). The distance between the pair of side members 401 in the vehicle width direction (Y direction) is wider than the main frame 30.

The first cross member 402 is a member that extends along the vehicle width direction (Y direction) and that connects the ends of the pair of side members 401 on the front end side. However, the first cross member 402 is divided into two on the right and left at a divided portion 402a at the center in the vehicle width direction so that the reinforcing member 404 is interposed therebetween.

The second cross member 403 is joined so as to connect the ends of the pair of side members 401 on the rear end side. The pair of side members 401, the first cross member 402, and the second cross member 403 form the outer shape of the rectangular rear end frame 40.

The reinforcing member 404 is a reinforcing member extending along the vehicle front-rear direction (X direction) at the center in the vehicle width direction (Y direction). The rear end side of the reinforcing member 404 comes into contact with the second cross member 403, and a welded portion 60 around the contact surface is welded. Further, the front end side of the reinforcing member 404 projects toward the main frame 30 through a gap in the central portion of the second cross member 403. The divided portion 402a of the divided first cross member 402 is welded at welded portions 61 on the outer periphery of the contact surface that is in contact with the reinforcing member 404. In the following description, the portion of the reinforcing member 404 further in the vehicle front direction (+X direction) than the first cross member 402 is referred to as “first reinforcement member 404a”, and the portion of the reinforcing member 404 further in the vehicle rear direction (—X direction) than the first cross member 402 is referred to as a “second reinforcing member 404b”. That is, the reinforcing member 404 of the present embodiment is configured as one member in which the first reinforcing member 404a and the second reinforcing member 404b are integrated so as to be in a straight line.

According to such a configuration, the inside of the rectangular frame surrounded by the rear end frame 40 is divided into two spaces on the right and left by the second reinforcing member 404b. The wheel 230 and its actuator 240 are housed in each of the divided inner spaces of the rear end frame 40.

### 3-3. Joint Structure of Main Frame 30 and Rear End Frame 40

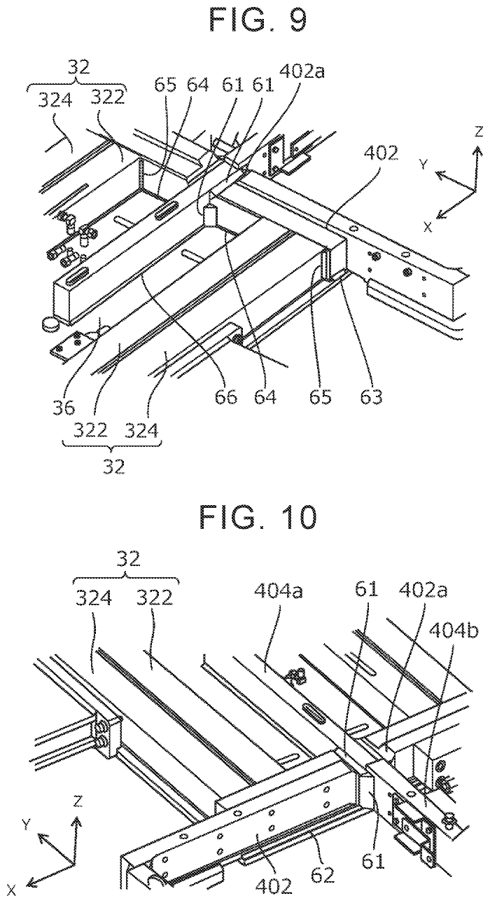

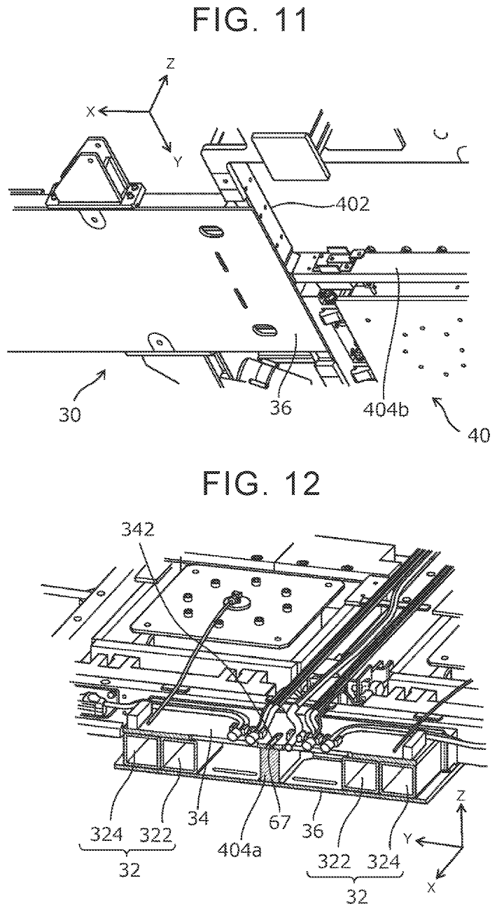

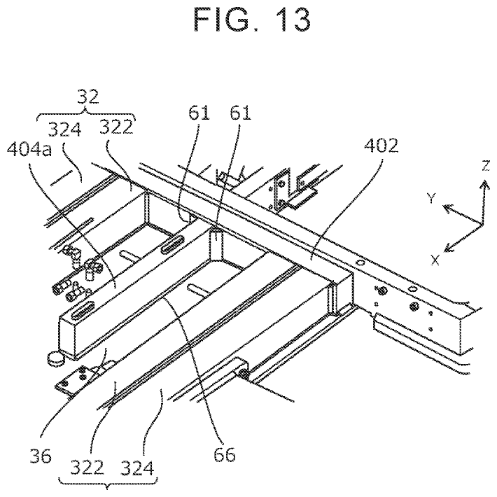

The bogie frame 200 of the present embodiment is characterized by a joint structure between the main frame 30 and the rear end frame 40. FIG. 9 is a perspective view of the joint portion between the main frame 30 and the rear end frame 40 as viewed diagonally from the front. FIG. 10 is a perspective view of the joint portion between the main frame 30 and the rear end frame 40 as viewed diagonally from the rear. FIG. 11 is an enlarged perspective view of the joint portion between the main frame 30 and the rear end frame 40 as viewed from the lower surface side of the vehicle. FIG. 12 is a perspective view of a bogie frame 200 cut along B-B in FIG. 6 and viewed from diagonally above. In FIGS. 9 to 12, illustration of parts not related to the joint structure between the main frame 30 and the rear end frame 40 is omitted as appropriate.

As shown in FIG. 11, the bottom plate 36 of the main frame 30 projects further toward the rear end side than the rear end of the first cross member 402 of the rear end frame 40. The bottom plate 36 is welded at welded portions 62, welded portions 63, and welded portions 64, which are boundaries of the portions that come into contact with the first cross member 402.

The pair of side frames 32 of the main frame 30 are welded at welded portions 65 that are in contact with the first cross member 402.

As shown in FIG. 12, the bottom surface side of the first reinforcing member 404a is in contact with the bottom plate 36 that is a part of the main frame 30. The first reinforcing member 404a is welded to the bottom plate 36 at a welded portion 66 that is the outer periphery of the contact surface with the bottom plate 36. Further, a plurality of through holes 342 is provided in the top plate 34 along a portion overlapping with the first reinforcing member 404a. Typically, the through hole 342 is an elongated hole extending along the longitudinal direction (X direction) of the top plate 34. The first reinforcing member 404a is groove-welded along a welded portion 67 on the entire circumference of the through hole 342 of the top plate 34.

According to the frame structure of the bogie frame 200 configured as described above, the main frame 30 and the rear end frame 40 are firmly joined. As a result, the bending strength of the bogie frame 200 against the weight of the transport target vehicle 1 can be increased without increasing the thickness in the height direction (Z direction).

### 4. Modification

The frame structure of the lift carrier 10 of the present embodiment may adopt a modified mode as follows.

FIG. 13 is a perspective view of the joint portion between the main frame 30 and the rear end frame 40 of the lift carrier 10 in a modification as viewed diagonally from the front. In the reinforcing member 404, the first reinforcing member 404a and the second reinforcing member 404b may be configured separately. In this case, the first cross member 402 is configured as one member without being divided into two on the right and left at the divided portion 402a, and the first reinforcing member 404a and the second reinforcing member 404b may each be abut-welded to the first cross member 402 at the welded portions 61 on the front side surface and the rear side surface of the first cross member 402.

What is claimed is:

1. A frame structure of a lift carrier comprising:
a bogie frame that is inserted under a transport target vehicle in a vehicle front-rear direction;
a plurality of arms configured to project outward from the bogie frame in a vehicle width direction at front and rear of ground contact portions of a plurality of tires of the transport target vehicle to support each of the tires in a supported state;
an elevating mechanism that raises and lowers the bogie frame in the supported state to raise and lower the transport target vehicle; and
a bogie body that is connected to a front end side of the bogie frame and is able to move the bogie frame to any location in the supported state, wherein:
the bogie frame is configured to include
a main frame extending from the front end side to a rear end side, and
a rear end frame joined to the main frame on the rear end side of the bogie frame;
the arms are provided on both sides of the main frame in the vehicle width direction and on both sides of the rear end frame in the vehicle width direction;
the rear end frame includes
a pair of side members, a distance between the side members in the vehicle width direction being wider than a width of the main frame,
a first cross member joined to ends of the side members on the front end side and to which the main frame is joined,
a second cross member joined so as to connect ends of the side members on the rear end side,
a first reinforcing member joined to the first cross member so as to project from the first cross member toward the front end side, and
a second reinforcing member joined to the first cross member so as to project from the first cross member toward the rear end side; and
the first reinforcing member is joined to a part of the main frame.

2. The frame structure according to claim 1, wherein:
the first reinforcing member and the second reinforcing member are configured as one integrated reinforcing member;
the first cross member is divided into two at a divided portion at a center; and
the reinforcing member is configured to be joined between the divided portion.

3. The frame structure according to claim 1, wherein:
the second reinforcing member extends to a position in contact with the second cross member of the rear end frame; and
the second reinforcing member is configured to be joined to the second cross member.

4. The frame structure according to claim 1, wherein:
the main frame includes
a pair of side members each having a square closed section and arranged side by side in parallel on right and left, and
a bottom plate joined to a lower side of the side members; and
the first reinforcing member is configured to be joined to the bottom plate.

5. The frame structure according to claim 4, wherein:
the main frame includes a top plate joined to an upper surface side of the side members;
the top plate is provided with one or a plurality of through holes at a position overlapping with the first reinforcing member; and
the first reinforcing member and the top plate are configured to be joined via the one or the plurality of through holes.

6. The frame structure according to claim 4, wherein:
the bottom plate extends to a position overlapping with the first cross member; and
the bottom plate is configured to be joined to the first cross member.
